(19) United States
(12) Patent Application Publication
(10) Pub. No.: US 2020/0327411 A1
(43) Pub. Date: Oct. 15, 2020

(54) Systems and Method on Deriving Real-time Coordinated Voltage Control Strategies Using Deep Reinforcement Learning

(71) Applicants: Di Shi, San Jose, CA (US); Jiajun Duan, San Jose, CA (US); Ruisheng Diao, San Jose, CA (US); Bei Zhang, San Jose, CA (US); Xiao Lu, Nanjing (CN); Haifeng Li, Nanjing (CN); Chunlei Xu, Nanjing (CN); Zhiwei Wang, San Jose, CA (US)

(72) Inventors: Di Shi, San Jose, CA (US); Jiajun Duan, San Jose, CA (US); Ruisheng Diao, San Jose, CA (US); Bei Zhang, San Jose, CA (US); Xiao Lu, Nanjing (CN); Haifeng Li, Nanjing (CN); Chunlei Xu, Nanjing (CN); Zhiwei Wang, San Jose, CA (US)

(21) Appl. No.: 16/842,500

(22) Filed: Apr. 7, 2020

Related U.S. Application Data
(60) Provisional application No. 62/833,776, filed on Apr. 14, 2019.

(51) Int. Cl. G06N 3/08; G06N 3/04; G06K 9/62; H04L 12/40

(52) U.S. Cl. CPC G06N 3/08; H04L 12/40039; G06K 9/6256; G06N 3/0454

(57) ABSTRACT

Systems and methods are disclosed for controlling a power system by formulating a voltage control problem using a deep reinforcement learning (DRL) method with a control objective of training a DRL-agent to regulate the bus voltages of a power grid within a predefined zone before and after a disturbance; performing offline training with historical data to train the DRL agent; performing online retraining of the DRL agent using live PMU data; and providing autonomous control of the power system below a sub-second after training.

This application claims priority to Provisional Application 62/833,776 filed Apr. 23 2019, the content of which is incorporated by reference.

### BACKGROUND

The present invention relates to autonomous control of power grids.

Modern power systems face significant challenges in regulating voltage profiles at all times, as voltage security is often threatened by the ever-increasing dynamics and stochastics caused by the growing penetration levels of renewables, demand response, power electronic interfaced devices, natural disasters, and protection relay malfunctions. In case of severe disturbances, rapidly restoring the fluctuating voltage profiles to normal is of great importance to ensure the secure and economic operation of a power grid. Traditionally, voltage control is performed at the device level with predetermined settings, e.g., at generator terminals or buses with shunt VAr resources or SVCs. The impact of such a control scheme is limited to have local impact without proper coordination. Large-scale offline studies are then needed to predict future representative operating conditions and then coordinate various voltage controllers before determining operational rules for use in real-time (mostly implemented through manual operation). Given the trend of increasing complexity and stochastic nature of the grid, the offline determined operational rules and study assumptions may be violated during the real-time operational environment, thus limiting the effectiveness of such offline-determined control decisions. Therefore, deriving effective and rapid voltage control rules for real-time conditions becomes critical to mitigate potential voltage issues.

### SUMMARY

In one aspect, systems and methods are disclosed for controlling a power system by formulating a voltage control problem using a deep reinforcement learning (DRL) method with a control objective of training a DRL-agent to regulate the bus voltages of a power grid within a predefined zone before and after a disturbance; performing offline training with historical data to train the DRL agent; performing online retraining of the DRL agent using live Phasor Measurement Unit (PMU) data; and providing autonomous control of the power system within a sub-second after training.

In another aspect, a method to control a power grid includes training DRL agents for providing data-driven, real-time and autonomous control strategies for regulating voltage profiles in a power grid, where the automatic voltage control (AVC) problem is formulated as a Markov decision process (MDP) so that it can take full advantages of state-of-the-art DRL algorithms that were proven to be effective in various real-world control problems in highly dynamic and stochastic environments. This invention enhances and extends the DRL-based algorithms for achieving the effective and more robust performance of AI agents considering practical constraints.

Advantages of the system may include one or more of the following. The system applies artificial intelligence (AI) for strategic control and decision making for various complex dynamic systems. Deep reinforcement learning (DRL) technique, is used for a bright solution for autonomous control of power grids. To enhance the stability of a single DQN agent, two architecture-identical deep neural networks are used, including one target network and one evaluation network. To overcome the limitations of the DQN agent that can only provide discrete control actions, a deep deterministic policy gradient (DDPG)-based method is used for training AI agents in providing continuous coordinated voltage controls. The algorithm is purely data-driven, without the need for accurate real-time system models for making coordinated voltage control decisions, once an AI agent is properly trained. Thus, a live PMU data stream from WAMS can be used to enable sub-second controls, which is valuable for scenarios with fast changes like renewable resource variations and system disturbances. During the training process, the agent is capable of self-learning by exploring more control options in a high dimension by jumping out of local optimal and therefore improves its overall performance. The formulation of DRL for voltage control is flexible as it can intake multiple control objectives and consider various security constraints, especially time-series constraints.

### BRIEF DESCRIPTION OF THE DRAWINGS

FIG. 1 shows an exemplary Voltage profile zone definition for training DRL agents.

FIG. 2 shows an exemplary overview of training and implementation of the DRL agents.

FIG. 3 shows an exemplary interaction between Agent and Environment in reinforcement learning.

FIG. 4 shows an exemplary flowchart of training a DRL Agent for coordinated voltage control.

FIG. 5 shows an exemplary process for applying DRL-based AVC control.

FIG. 6 shows an exemplary power grid control system.

### DESCRIPTION

A power control framework is detailed that: 1) formulate the AVC problem of power system using DRL 2) design the reward function to achieve the control objective 3) propose two types of deep reinforcement learning (DRL), and applying a deep-Q-network (DQN) with a deep-deterministic-policy-gradient (DDPG) method, provide AVC commands for discrete and continuous action spaces.

To resolve the aforementioned issues, hierarchical AVC systems with multiple-level coordination were proposed and deployed in the field, which typically consists of 3 levels of control (primary, secondary and tertiary). (a) At the primary level, automatic voltage regulators are used to maintaining local voltage profiles, through excitation systems with a response time of several seconds. (b) At the secondary level, control zones, either determined statically or adaptively (e.g., using sensitivity-based approach), need to be formed first where a few pilot buses are identified; the control objective is to coordinate all reactive power resources in each zone for regulating voltage profiles of the selected pilot buses only, with a response time of several minutes. (c) At the tertiary level, the objective is to minimize power losses by adjusting setpoints of those zonal pilot buses while respecting security constraints, with a response time of 15 minutes to several hours. Similarly, a two-level automatic voltage control (AVC) system was proposed in [3] which optimizes voltage control measures (optimal reactive power flow control and corrective voltage control) without the need for forming zones a priori. The core technologies behind these techniques are based on optimization methods, e.g., AC optimal power flow considering various constraints, which works well the majority of the time in the real-time environment; however, certain limitations still exist that may affect the voltage control performance, including:

(1) They require relatively accurate real-time system models to achieve the desired control performance, which depends upon the real-time EMS snapshots running every few minutes. The control measures derived for the captured snapshots may not function well if significant disturbances or topology changes occur in the system between two adjacent EMS snapshots.

(2) For a large-scale power network, coordinating and optimizing all controllers in a high dimensional space is challenging, and may require a long solution time or in rare cases, fail to reach a solution. Suboptimal solutions can be used for practical implementation. For diverged cases, the control measures of the previous day or historically similar cases are used.

(3) Sensitivity-based methods for forming controllable zones are subject to high complexity and nonlinearity in a power system in which the zone definition may change significantly with different operating conditions with various topologies and under contingencies.

(4) Optimal power flow (OPF) based approaches are typically designed for single system snapshots only, making it difficult to coordinate control actions across multiple time steps while considering practical constraints, i.e., capacitors should not be switched on and off too often during one operating day.

The instant DRL-based framework for coordinated voltage control is general and can be adapted to various control objectives considering security constraints. While DRL is used, other approaches can be modified such as voltage control problems traditionally modeled as OPF problems. Thus, the corresponding modeling techniques in DRL are provided and compared in Table I.

TABLE I
COMPARISON OF MODELING TECHNIQUES IN COORDINATED VOLTAGE
CONTROL USING OPF AND DRL BASED METHODS

| | |
|---|---|
| OPF-based | DRL-based |

Control Objectives Modelled

| | | |
|---|---|---|
| Corrective | (1) as hard constraints so that: | as reward accumulated per control |
| Actions | Vᵢ^{min} ≤ Vᵢ ≤ Vᵢ^{max}, i ∈ B and/or | iteration, discounted over the long |
| | (2) as an objective function | run: |
| | for fewer control actions: min Σₖ^{Kmax} c(k),k ∈ C | $arg {max}_{a} {Q}^{*} ( s , a )$ |
| Loss | as the objective function: min | included in reward design, by |
| Minimization | Σ_{i,j}Pₗₒₛₛ (i, j), (i, j) ∈ Ω_{L} ∪ Ω_{T} | penalizing large power losses |

Constraints Modelled

| | | |
|---|---|---|
| AC Power Flow Constraints | ${P}_{i}^{g} - {P}_{i}^{d} - {g}_{i} {V}_{i}^{2} = {\sum }_{j ∈ {B}_{i}} {P}_{ij} ( y ) , i ∈ B$ ${Q}_{i}^{g} - {G}_{i}^{d} - {b}_{i} {V}_{i}^{2} = {\sum }_{j ∈ {B}_{i}} {Q}_{ij} ( y ) , i ∈ B$ where y = [θ V]^{T} ${P}_{i}^{g} = {\sum }_{n ∈ Gi} {P}_{n}^{g} , i ∈ B$ ${Q}_{i}^{g} = {\sum }_{n ∈ Gi} {Q}_{n}^{g} , i ∈ B$ ${P}_{i}^{d} = {\sum }_{m ∈ Di} {P}_{m}^{d} , i ∈ B$ ${Q}_{i}^{d} = {\sum }_{m ∈ Di} {Q}_{m}^{d} , i ∈ B$ | respected by AC power flow solvers, used as an environment to train DRL agents |
| | Pᵢⱼ and Qᵢⱼ are active power | |
| | and reactive power on branches, | |
| | respectively | |
| Generation | Pₙ^{min} ≤ Pₙ ≤ Pₙ^{max}, n ∈ G | respected by AC power flow solver |
| Limits | Qₙ^{min} ≤ Qₙ ≤ Qₙ^{max}, n ∈ G | as the environment |
| Voltage | Vᵢ^{min} ≤ Vᵢ ≤ Vᵢ^{max}, i ∈ G | included in reward design |
| Limits | | shown above |
| Transmission | Pᵢⱼ²+Qᵢⱼ² ≤ Sij^{max}, (i, j) ∈ Ω_{L} ∪ Ω_{T} | included in reward design by |
| Line Limits | | penalizing overflow, if needed |

This system provides for training DRL agents for providing data-driven, real-time and autonomous control strategies for regulating voltage profiles in a power grid, where the AVC problem is formulated as a Markov decision process (MDP) so that it can take full advantages of state-of-the-art DRL algorithms that were proven to be effective in various real-world control problems in highly dynamic and stochastic environments. This system enhances and extends the DRL-based algorithms for achieving the effective and more robust performance of AI agents considering practical constraints.

Real-Time Coordinated Voltage Control Using DRL

A. Coordinated Voltage Control Problem Formulated as a Markov Decision Process

An MDP represents a discrete time stochastic control process, which provides a general framework for modeling the decision-making procedure for a stochastic and dynamic control problem. For the problem of coordinated voltage control, a 4-tuple can be used to formulate the MDP, (S, A, Pₐ, Rₐ), where S is a vector of system states, including voltage magnitudes and phase angles across the system or areas of interest; A is a list of actions to be taken, e.g., generator terminal bus voltage setpoints, status of shunts and tap ratios of regulating transformers; Pₐ(s, s′)=Pr(sᵢ₊₁=s′|sᵢ=s, aᵢ=a) represents the transition probability from the current state sᵢ to a new state, sᵢ₊₁, after taking an action a at time=i; Rₐ(s, s′) is the reward received after reaching state, s′, from the previous state, s, to quantify the overall control performance.

The MDP is solved to determine an optimal “policy”, π(s), which can specify actions based on states so that the expected accumulated rewards, typically modelled as a Q-value function, Q^{π}(s, a), can be maximized in the long run, given by:

Q^{π}(s,a)= [symbol] (rᵢ₊₁+γrᵢ₊₂+γ²rᵢ₊₃+ . . . |s,a) (1)

Then, an optimal value function is the maximum achievable value given as:

$$Q * ( s , a ) = {max}_{π} {Q}^{π} ( s , a ) = {q}^{{π}^{*}} ( s , a ) \qquad ( 2 )$$

Once Q* is known, the agent can act optimally as:

$${π}^{*} ( s ) = arg {max}_{a} {Q}^{*} ( s , a ) \qquad ( 3 )$$

Accordingly, the optimal value of Q that maximizes over all decisions can be expressed as:

$${Q}^{*} ( s , a ) = {r}_{i + 1} + γ {max}_{{a}_{i + 1}} {r}_{i + 2} + {γ}^{2} {max}_{{a}_{i + 2}} {r}_{i + 3} \qquad ( 4 )$$

Essentially, the process in (1)-(4) is a Markov Chain process. Since the future rewards are now easily predictable by neural networks, the optimal value can be decomposed into a more condensed form as a Bellman equation:

$${Q}^{*} ( s , a ) = {E}_{{s}^{′}} [ r + γ {max}_{{a}^{′}} {Q}^{*} ( {s}^{′} , {a}^{′} ) \vert s , a ] \qquad ( 5 )$$

where γ is a discounted factor. This problem can then be solved using many state-of-the-art RL algorithms.

B. Design of Episodes, Rewards, States, and Action Space

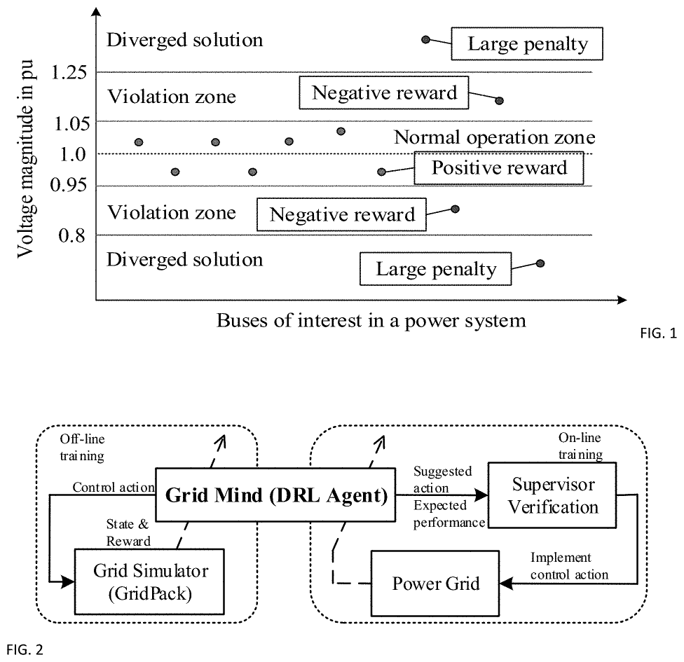

Without loss of generality, this system trains effective DRL agents for providing prompt corrective control measures once voltage violations are detected. It is worth mentioning voltage limits considered can be adjusted/narrowed to make the proposed framework work for preventive control. Constraints considered in this study include full AC power flow equations, generation limits and voltage limits. FIG. 1 illustrates the desired control objective of training a DRL-agent, which is to regulate the bus voltages of a power grid within a predefined zone before and after a disturbance.

1) Episode

An episode can start from any quasi-steady-state system operating condition that can be captured by EMS snapshots, SCADA or PMU measurements. Without any voltage violations, no actions need to be taken, which can also be modeled as a null action taken by DRL agent. However, due to variations in system loads, renewable generation and contingencies, once voltage issues occur, the DRL agent starts to take actions selected from an action space in order to fix the voltage issues. For each iteration of applied control actions, the control performance is calculated in terms of reward values. The episode terminates when any of the three conditions is met: i) no more voltage violations; ii) power flow diverges; iii) the maximum iteration number, e.g., 200, is reached. To train effective agents, massive representative operating conditions need to be collected or created, including random load changes, variations in renewable generation, generation dispatch patterns, major topology changes due to maintenance and contingencies.

2) Reward

As illustrated in Error! Reference source not found., the reward for each control iteration can be calculated by three different voltage levels, i.e., normal zone (0.95˜1.05 p.u.), violation zone (0.8˜0.95 p.u. or 1.05˜1.25 p.u.) and divergence zone (<0.8 pu or >1.25 pu). Suppose Vⱼ is the voltage magnitude at bus j, the reward rᵢ for the i^{th} control iteration is calculated as:

$${r}_{i} = \{ \begin{matrix}\begin{matrix}Postive Reward ( + {R}_{p} ) , ∀ {V}_{j} ∈ [ 0.95 , 1.05 ] pu \\ Negative Reward ( - {R}_{n} ) , ∃ {V}_{j} ∉ [ 0.95 , 1.05 ] pu\end{matrix} \\ Large Penalty ( - {R}_{e} ) , power flow diverges\end{matrix} \qquad ( 6 )$$

Then, the final reward r_{f} for an entire episode containing n iterations can be derived as

r_{f}=Σ₁ⁿrᵢ/n (7)

In this manner, a higher reward indicates more efficient control strategies (less iteration) to solve the voltage problems. A DRL agent is motivated to regulate system voltages within the desired normal zone by maximizing the total reward for the episode. It is worth mentioning that the design of the reward can be diversified serving different optimization purposes, i.e., a higher reward is given when more voltages are closer to 1 pu and a lower reward is assigned with more voltage violations, to achieve a more unified voltage profile across the entire system. Reward can also be designed to minimize the system loss or to balance multiple control objectives.

3) State Space

For the purpose of coordinated voltage control, states are defined as a vector of voltage magnitudes, phase angles, and active and reactive power flows on branches that can be directly provided by EMS or WAMS systems. To maintain consistency of different inputs and outputs with various units when training DRL agents, the batch normalization technique is applied. By defining values of x over a mini-batch to be B={x_{1 . . . m}}, the mean value of this mini-batch can be calculated as:

$${μ}_{B} = \frac{1}{m} {\sum }_{i = 1}^{m} {x}_{i} \qquad ( 8 )$$

The variance of mini-batch can be calculated as

$${σ}_{B}^{2} = \frac{1}{m} {\sum }_{i = 1}^{m} {( {x}_{i} - {μ}_{B} )}^{2} \qquad ( 9 )$$

Then, the normalized mini-batch can be expressed as

$${x}_{i}^{*} = \frac{{x}_{i} - {μ}_{B}}{\sqrt{{σ}_{B}^{2} + ϵ}} \qquad ( 10 )$$

where ϵ is a constant applied to the mini-batch variance for numerical stability. Finally, the mini-batch can be scaled and shifted by

yᵢ=γx*ᵢ+β≡BN_{(γ,β)} (11)

where γ and β are parameters to be learned to fine-tune the normalized mini-batch. Considering that the input features may contain redundancy, a 50% layer-dropout is applied during the regularization process.

4) Action Space

For regulating voltages, there are several types of common actions, such as changing voltage set points of generator terminal buses, adjusting transformer tap-ratios and switching shunt capacitors or reactors. In this system, without loss of generality, the control action space is formed by the voltage set points of selected generators in the system, in the range [0.95, 1.05]. Other types of controls can be added to enhance the action space if needed, when training DRL agents. For DRL agents supporting only discrete types of control like DQN, the continuous action space is discretized into five values per power plant, namely, [0.95, 0.975, 1.0, 1.025, 1.05]. For a power grid with N power plants used for voltage control, the total combination of all possible control actions forms a space in the dimension of 5^{N}. The space grows exponentially as a power grid grows bigger; thus, permutation techniques can be used to effectively reduce the dimension. However, for DRL agents supporting continuous action space searching like DDPG, the total dimension is equal to N for the same power system when regulating system voltage profiles.

I. DRL Algorithms for Discrete and Continuous Control Action Spaces

There are three main reinforcement learning methods: model-based (e.g., dynamic programming method), policy-based (e.g., Monte Carlo method) and value-based (e.g., Q-learning and SARSA method). The latter two are model-free methods, indicating they can interact with the environment directly without the need for environment model, and can handle problems with stochastic transitions and rewards. Through intensive literature reviews, the inventors adopt and enhance the DQN and DDPG algorithms in this work to demonstrate the effectiveness of the proposed method. A high-level overview of the training procedure and implementation of both DRL agents is shown below.

A. An Enhanced Deep-Q Network (DQN) Algorithm

The DQN method is derived from the classic Q-learning method when integrated with DNN. The states, actions and Q-values in Q-learning method are stored in a Q-table. The Q-table is not capable of handling a large dimension of states or actions. To resolve this issue, in DQN, neural networks are used to approximate the Q-function instead of using a Q-table, which allows continuous state inputs. The updating principle of the Q-value NN in the DQN method can be expressed as:

Q′_{(s,a)}=Q_{(s,a)}+α[r+γ max Q_{((s′,a′))}−Q_{(s,a)}] (12)

where Q′_{(s,a)} is the updated Q-value with a as the learning rate and γ as the discount rate. The parameters of the NN are updated by minimizing the error between the actual and estimated Q-values [r+γ max Q_{(s′,a′)}−Q_{(s,a)}]. In this work, there are two specific designs that make DQN a promising candidate for coordinated voltage control, namely experience replay and fixed Q-targets. Firstly, DQN has an internal memory to restore the past-experience and learn from it repeatedly. Secondly, to mitigate the overfitting problem, two NNs are used in the enhanced DQN method, with one being a target network and the other an evaluation network. Both networks share the same structure, but with different parameters. The evaluation network keeps updating its parameters with training data. The parameters of the target network are fixed and periodically get updated from the evaluation network. In this way, the training process for the DQN becomes more stable. The pseudo code for training and testing the DQN agent is presented in Table II.

TABLE II
ALGORITHM FOR TRAINING THE DQN AGENT

```
Input: system states (Pₗᵢₙₑ, Qₗᵢₙₑ, V_{bus}, θ_{bus})
Output: generator voltage set points
Initialize the relay memory R to capacity C
Initialize value function Q with weight θ
Initialize target value function \hat{Q} with weight \hat{θ}
Initialize the probability of applying random action pᵣ(0) = 1
for episode = 1 to M do
  Initialize the power flow and get state s
  for iteration = 1 to T do
    With probability ε select a random action a
    $Otherwise select a = arg {max}_{a} Q ( s \vert θ )$
    redo power flow, get new state s′ and reward r
    Store transition (s, a, r, s′) in D
    Sample random mini batch of transition (sᵢ, aᵢ, rᵢ, s′ᵢ) in D
    $Set {z}_{i} = \{ \begin{matrix}{r}_{i} , & if episode terminates at at i + 1 \\ {r}_{i} + {γ max}_{a} \hat{Q} ( {s}^{′} , {a}^{′} \vert \hat{θ} ) , & otherwise\end{matrix}$
    Perform gradient descent on (z_{I} − Q(s_{I}, a_{I}|θ))² with respect to θ
    Reset \hat{Q} = Q every C steps
    if no voltage violations, end for
  while pᵣ (i) > Pᵣₘᵢₙ
  Pᵣ (i + 1) = 0.95 pᵣ (i)
end for
```

During the exploration period, the decaying e-greedy method is applied, which means the DQN agent has a decaying probability of e to make a random action selection at the i^{th} iteration. And εᵢ can be updated as

$${ɛ}_{i + 1} = \{ \begin{matrix}{r}_{i} \times {ɛ}_{i} , & if {ɛ}_{i} > {ɛ}_{min} \\ {ɛ}_{m i n} & else\end{matrix} \qquad ( 13 )$$

where r_{d} is a constant decay rate.

B. Deep Deterministic Policy Gradient (DDPG)

One concern of the DQN method is that the agent has to assign every single action with a matched Q-value based on the current states. Thus, DQN is suitable for solving control problems with discrete actions in relatively low dimension. If an action space contains infinite (continuous) variables, the DQN will lose effectiveness due to the curse of dimensionality. From this perspective, the policy-gradient-based approach such as deep deterministic policy gradient provides a promising solution.

DDPG is a combination of actor-critic-based method and policy-gradient-based method. It contains a policy network working as an actor to generate the action and a value network serving as a critic to evaluate the action. Similar to the enhanced DQN, both policy network and value network use two separate NNs that update at different paces to keep training process more stable. In addition, DDPG also has a memory to restore the past-experience and replay for learning. When sampling a random minibatch of N transitions (sᵢ, aᵢ, rᵢ, sᵢ₊₁), the actor is updated by applying the chain rule to expected return from the starting distribution J:

$${∇}_{{θ}^{μ}} J \approx \frac{1}{N} {\sum }_{i} {∇}_{a} Q ( s , a \vert {θ}^{Q} ) {{\vert}_{s = {s}_{i} , a = μ ( {s}_{i} )} {∇}_{{θ}^{μ}} μ ( s \vert {θ}^{μ} ) \vert}_{{s}_{i}} \qquad ( 14 )$$

where the action is directly calculated using a parameterized actor function a=μ(s|θ^{μ}) with θ^{μ} as the parameters of the policy network, and θ^{Q} as parameters of the value network.

Then, by defining wᵢ=rᵢ+γ\hat{Q}(sᵢ₊₁, \hat{μ}(sᵢ₊₁|\hat{θ}^{μ})|\hat{θ}^{Q}), the critic is updated by minimizing the loss function L,

$$L = \frac{1}{N} {\sum }_{i} {( {w}_{i} - Q ( {s}_{i} , {a}_{i} \vert {θ}^{Q} ) )}^{2} \qquad ( 15 )$$

In DDPG, the target networks are updated using a different soft replacement method as:

$$\{ \begin{matrix}{\hat{θ}}^{Q} ← τ {θ}^{Q} + ( 1 - τ ) {\hat{θ}}^{Q} \\ {\hat{θ}}^{μ} ← τ {θ}^{μ} + ( 1 - τ ) {\hat{θ}}^{μ}\end{matrix} \qquad ( 16 )$$

where \hat{θ}^{Q} and \hat{θ}^{μ} are parameters of target networks for value network θ^{Q} and policy network θ^{μ}, respectively. x is a small updating coefficient. The pseudo code for training the DDPG agent is shown in Table III.

For the DDPG approach, the action is directly calculated by the agent within a given bound, e.g., [0.95, 1.05] p.u. During the exploration process, the exploration policy μ′ is designed by adding a random decaying noise ξ as

μ′(sᵢ)=μ(sᵢ|θ^{μ})+ξᵢ (17)

where ξᵢ₊₁=r_{d}×εᵢ.

TABLE III
ALGORITHM FOR TRAINING THE DDPG AGENT

```
Input: system states (Pₗᵢₙₑ, Qₗᵢₙₑ, V_{bus}, θ_{bus})
Output: generator voltage set points
Initialize the relay memory R to capacity C
Initialize critic network Q(s, a|θ^{Q}) and actor μ(s|θ^{μ}) with weights θ^{Q} and θ^{μ}
Initialize target network \hat{Q} and \hat{μ} with weights \hat{θ}^{Q}, \hat{θ}^{μ}
Initialize the exploration noise ξ₀
for episode = 1 to M do
  Initialize the power flow and get state s
  for iteration = 1 to T do
    Select action according to a = μ(s|θ^{μ}) + ξ
    redo power flow, get new state s′ and reward r
    Store transition (s, a, r, s′) in D
    Sample random mini batch of transition (sᵢ, aᵢ, rᵢ, s′ᵢ) in D
    $Set {w}_{i} = \{ \begin{matrix}{r}_{i} , & if episode terminates at i + 1 \\ {r}_{i} + γ \hat{Q} ( {s}_{i + 1} , \hat{μ} ( {s}_{i + 1} \vert {\hat{θ}}^{μ} ) \vert {\hat{θ}}^{Q} ) , & otherwise\end{matrix}$
    Update critic by minimizing the loss in (15)
    Update the actor policy using (14)
    Update the target network using (16)
    if no voltage violations, end for
end for
```

The competitive/commercial values of this system are summarized below:
(1) To enhance the stability of a single DQN agent, two architecture-identical deep neural networks are used, including one target network and one evaluation network.
(2) To overcome the limitations of the DQN agent that can only provide discrete control actions, a DDPG-based method is proposed for training AI agents in providing continuous coordinated voltage controls.
(3) The proposed algorithm is purely data-driven, without the need for accurate real-time system models for making coordinated voltage control decisions, once an AI agent is properly trained. Thus, a live PMU data stream from WAMS can be used to enable sub-second controls, which is valuable for scenarios with fast changes like renewable resource variations and system disturbances.
(4) During the training process, the agent is capable of self-learning by exploring more control options in a high dimension by jumping out of local optimal and therefore improves its overall performance.
(5) The formulation of DRL for voltage control is flexible as it can intake multiple control objectives and consider various security constraints, especially time-series constraints.

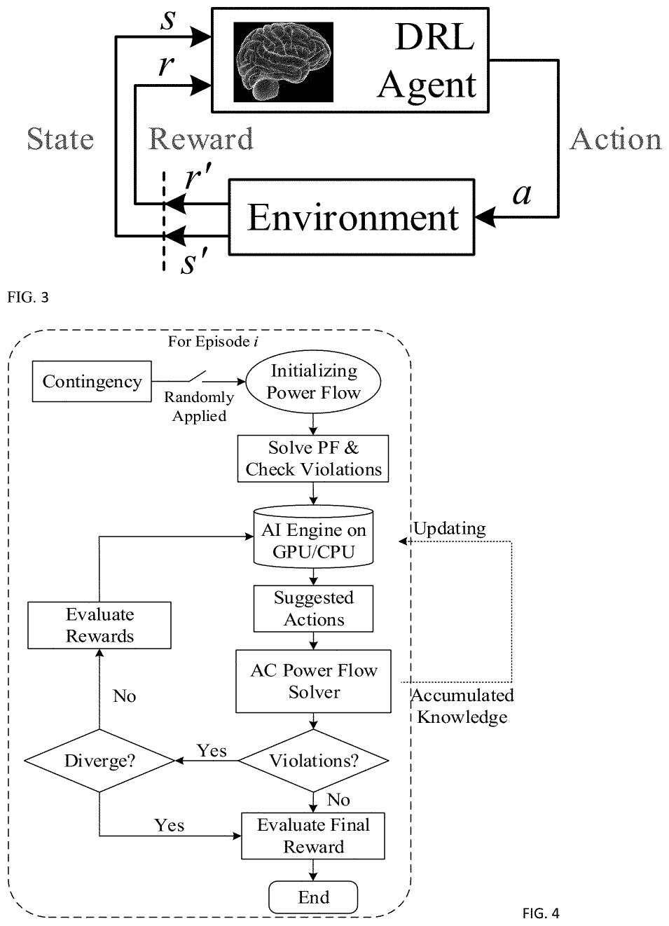

DRL is essentially developed from the classic reinforcement learning technique when combining with deep neural network (DNN) that consists of many layers. It provides a promising approach to solve the MDP problem and addresses the real-time decision-making/control problem in a complex, stochastic and highly dynamic system environment. A general interaction process between the agent and the environment in DRL is presented in FIG. 3. After receiving the current states from the environment, a DRL agent generates a corresponding action using its policy; then, the environment provides the next state (s′) and the corresponding reward (r′) for the executed action. Through such massive interactions, the DRL agent keeps optimizing its policy to maximize the accumulated rewards. In this way, the DRL agent will gradually master the control problem after a certain period of training.

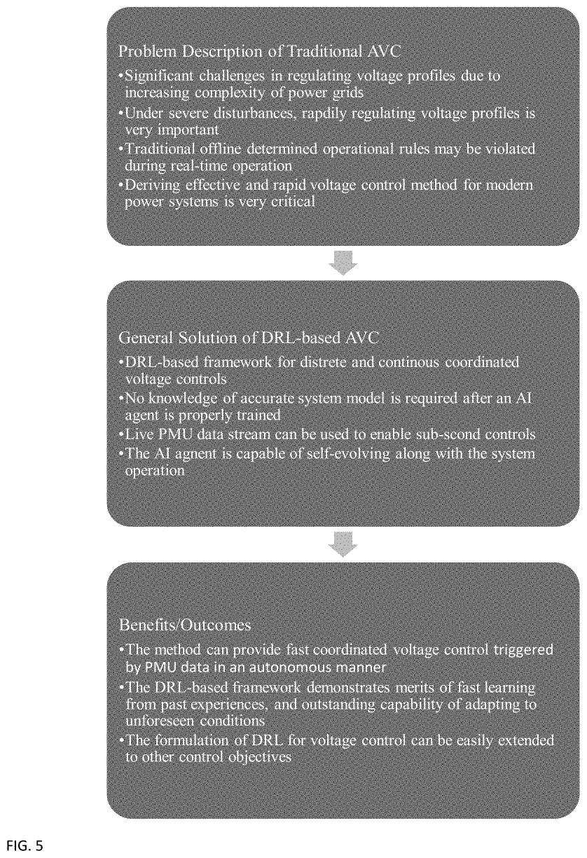

FIG. 3 illustrates a sample interaction between Agent and Environment in reinforcement learning, while the main flowchart for training DRL Agents for coordinated voltage control is shown in FIG. 4, consisting of four major steps:

Step 1: for an operating condition (offline or online), the environment (i.e., high-fidelity power flow solver) solves the power flow and check for potential voltage violation.

Step 2: if a voltage violation occurs, the DRL agent will suggest actions and predict the expected rewards.

Step 3: the environment takes the actions and provides the updated states and calculates the corresponding rewards for these actions.

Step 4: the DRL agent optimizes and updates its policy parameters based on the accumulated knowledge during the massive interaction process with the environment. For online application, grid simulation using the DRL controls can be conducted for verifying its performance before actual implementation. More details regarding the DRL training and implementation procedures are provided in the subsequent sections.

FIG. 4 shows an exemplary computational flowchart of training a DRL Agent for coordinated voltage control. As shown therein, the formulation of the AVC problem for the power system is unique. The DRL-based framework is data-driven using a live PMU data stream without the need for the system model. The training the DRL agent to solve the voltage control problem is unique. The DRL agent can learn from the historical data and experience of the system operator to solve future unseen system problems. The developed control framework can handle both discrete and continuous action space. It can comprehensively utilize the control resources in power systems. The flowchart of FIG. 4 performs the following operations:

1. Formulate the voltage control problem using DRL-based data-driven method

2. Set up the offline training environment and use historical data to train the DRL agent from scratch

3. Online retrain the DRL agent using live PMU data

4. Provide the autonomous control strategies within sub-second after well training.

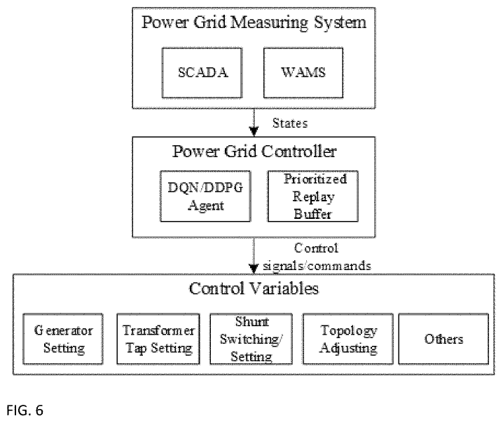

FIG. 6 shows an exemplary power grid control system. The system includes a power grid measurement system with SCADA and WAMS. The states are provided to a power grid controller with DQN/DDPG agent and a prioritized replay buffer. The control signals are then provided as control variables for generator setting, transformer tap setting, shunt switching setting, topology adjustments, among others.

As described above, although the exemplary embodiments of the present invention have been set forth with reference to the drawings, they are merely illustrative of the present invention, and the aforementioned combinations and various configurations other than those stated above can be adopted.

What is claimed is:

1. A method for controlling a power system, comprising:
formulating a voltage control problem using a deep reinforcement learning (DRL) method with a control objective of training a DRL-agent to regulate the bus voltages of a power grid within a predefined zone before and after a disturbance;
performing offline training with historical data to train the DRL agent;
performing online retraining of the DRL agent using live PMU data; and
providing autonomous control of the power system below a sub-second after training.

2. The method of claim 1, wherein the DRL agent selects a solution from an action space to fix voltage issues due to variations in system loads, renewable generation and contingencies.

3. The method of claim 1, wherein representative operating conditions are collected or created, including random load changes, variations in renewable generation, generation dispatch patterns, major topology changes due to maintenance and contingencies.

4. The method of claim 1, where Vⱼ is the voltage magnitude at bus j, determining a reward rᵢ for the i^{th} control iteration as:
$${r}_{i} = \{ \begin{matrix}\begin{matrix}Postive Reward ( + {R}_{p} ) , ∀ {V}_{j} ∈ [ 0.95 , 1.05 ] pu \\ Negative Reward ( - {R}_{n} ) , ∃ {V}_{j} ∉ [ 0.95 , 1.05 ] pu\end{matrix} \\ Large Penalty ( - {R}_{e} ) , power flow diverges\end{matrix}$$
and determining a final reward r_{f} for an entire episode containing n iterations as r_{f}=Σ₁ⁿrᵢ/n.

5. The method of claim 1, comprising providing rewards to minimize the system loss or to balance multiple control objectives.

6. The method of claim 1, comprising defining states as a vector of voltage magnitudes, phase angles, and active and reactive power flows on branches directly provided by EMS or WAMS systems coordinated voltage control.

7. The method of claim 1, wherein for a power grid with N power plants used for voltage control, a total combination of control actions forms a space in the dimension of 5N.

8. The method of claim 1, wherein the DRL agent supporting continuous action space searching comprises a total dimension of N for the power system when regulating system voltage profiles.

9. The method of claim 1, comprising training the DRL agent offline in a simulator and training on-line with supervisor verification on the power system.

10. The method of claim 1, comprising applying DQN reinforcement learning by combining Q-Learning with two or more deep neural networks for reinforcement learning in a high-dimensional environment, wherein parameters of the target network are fixed and periodically updated from an evaluation network.

11. The method of claim 10, during an exploration period, applying a decaying ε-greedy method where the DQN agent has a decaying probability of εᵢ to make a random action selection at the i^{th} iteration and εᵢ is updated as
$${ɛ}_{i + 1} = \{ \begin{matrix}{r}_{d} \times {ɛ}_{i} , & if {ɛ}_{i} > {ɛ}_{m i n} \\ {ɛ}_{m i n} , & else\end{matrix}$$
where r_{d} is a constant decay rate.

12. The method of claim 1, comprising applying Deep Deterministic Policy Gradients (DDPG) reinforcement learning, wherein the target network is updated using:
$$\{ \begin{matrix}{\hat{θ}}^{Q} ← τ {θ}^{Q} + ( 1 - τ ) {\hat{θ}}^{Q} \\ {\hat{θ}}^{μ} ← τ {θ}^{μ} + ( 1 - τ ) {\hat{θ}}^{μ}\end{matrix}$$
where \hat{θ}^{Q} and \hat{θ}^{μ} are parameters of target networks for value network θ^{Q} and policy network θ^{μ}, respectively and τ is an updating coefficient.

13. A system for controlling a power system, comprising:
a processor;
power sensors coupled to the processor and a grid;
a deep reinforcement learning (DRL) code with a control objective of training a DRL-agent to regulate the bus voltages of a power grid within a predefined zone before and after a disturbance;
code for performing offline training with historical data to train the DRL agent;
code for performing online retraining of the DRL agent using live PMU data; and
code for providing autonomous control of the power system below a sub-second after training.

14. The system of claim 13, wherein the DRL agent selects a solution from an action space to fix voltage issues due to variations in system loads, renewable generation and contingencies.

15. The system of claim 13, wherein representative operating conditions are collected or created, including random load changes, variations in renewable generation, generation dispatch patterns, major topology changes due to maintenance and contingencies.

16. The system of claim 13, where Vⱼ is the voltage magnitude at bus j, determining a reward rᵢ for the i^{th} control iteration as:
$${r}_{i} = \{ \begin{matrix}\begin{matrix}Postive Reward ( + {R}_{p} ) , ∀ {V}_{j} ∈ [ 0.95 , 1.05 ] pu \\ Negative Reward ( - {R}_{n} ) , ∃ {V}_{j} ∉ [ 0.95 , 1.05 ] pu\end{matrix} \\ Large Penalty ( - {R}_{e} ) , power flow diverges\end{matrix}$$
and determining a final reward r_{f} for an entire episode containing n iterations as r_{f}=Σ₁ⁿrᵢ/n.

17. The system of claim 13, comprising code for providing rewards to minimize the system loss or to balance multiple control objectives.

18. The system of claim 13, comprising code for training the DRL agent offline in a simulator and training on-line with supervisor verification on the power system.

19. The system of claim 13, comprising code for applying DQN reinforcement learning by combining Q-Learning with two or more deep neural networks for reinforcement learning in a high-dimensional environment, wherein parameters of the target network are fixed and periodically updated from an evaluation network.

20. The system of claim 19, during an exploration period, code for applying a decaying ε-greedy method where the DQN agent has a decaying probability of εᵢ to make a random action selection at the i^{th} iteration and εᵢ is updated as
$${ɛ}_{i + 1} = \{ \begin{matrix}{r}_{d} \times {ɛ}_{i} , & if {ɛ}_{i} > {ɛ}_{m i n} \\ {ɛ}_{m i n} , & else\end{matrix}$$
where r_{d} is a constant decay rate.

21. The system of claim 13, comprising an exemplary power grid control system with SCADA and WAMS, wherein power states are provided to the DRL code and a prioritized replay buffer and generated control signals are then provided as control variables for generator setting, transformer tap setting, shunt switching setting, and topology adjustments.
